(19) United States
(12) Patent Application Publication
(10) Pub. No.: US 2017/0302183 A1
(43) Pub. Date: Oct. 19, 2017

(54) PULSED LINEAR POWER CONVERTER

(71) Applicant: ZENTRUM MIKROELEKTRONIK DRESDEN AG, Dresden (DE)

(72) Inventor: Chris YOUNG, Round Rock, CA (US)

(21) Appl. No.: 15/517,149

(22) PCT Filed: Sep. 15, 2015
(86) PCT No.: PCT/EP2015/071050

§ 371 Date: Apr. 5, 2017

Related U.S. Application Data
(60) Provisional application No. 62/060,245, filed on Oct. 6, 2014.

(51) Int. Cl. H02M 3/158; H02M 1/00

(52) U.S. Cl. CPC H02M 3/158; H02M 2001/0032; H02M 2001/0045

(57) ABSTRACT

The present invention relates to a switchable power converter comprising a switchable power stage for generating an output voltage according to a switching signal and an input voltage by means of a switching element comprising a high-side switch and a low-side switch. In a light load mode, the controller is configured to disable, i.e. turn off, the low-side switch and to generate the switching signal to partially turn on the high-side switch during an on-time of the switching signal. Partially turning on the high-side switch is achieved by operating the high-side switch in its linear region.

### RELATED APPLICATIONS

This application is a 371 national stage application of International Patent Application No. PCT/EP2015/071050 filed Oct. 6, 2015, which claims priority to U.S. Provisional Patent Application No. 62/060,245 filed Oct. 6, 2014, which are incorporated herein by reference in their entirety as part of the present disclosure.

### FIELD OF THE INVENTION

The present disclosure relates to a pulsed linear power converter.

### BACKGROUND OF THE INVENTION

Contemporary designs of a power converter are chosen to meet specified performance requirements, such as high efficiency, accurate output regulation, fast transient response, low solution cost, etc. A power converter generates an output voltage and current for a load from a given input voltage. It needs to meet the current regulation or load voltage requirement during steady-state and transient conditions. Depending on the specific application, a linear power converter or a switched power converter may be an appropriate solution.

Linear power converters are suitable for powering very low powered devices. They are simple and inexpensive. However, due to the way they work, they are extremely inefficient.

A linear power converter works by taking the difference between the input and output voltages, and dissipating the power difference as waste heat. The larger the difference between the input and output voltage, the more heat is generated. In many cases, a linear power converter wastes more power stepping down the voltage than it actually ends up delivering to the target device.

FIG. 1 shows a linear power converter 11, an output capacitor 14 and a load 12. The linear power converter 11 comprises a field effect transistor FET operated in its linear mode, thus working as a variable resistor in series with the load 12. Furthermore, the linear power converter 11 comprises a feed-back loop to dynamically adjust the resistance of the FET 13.

To establish the feed-back loop, the error amplifier 15 senses the output voltage via a sampling resistor network RA and RB and then compares the feed-back voltage VFB with a reference voltage VREF. The error amplifier output voltage drives the gate of the FET. When either the input voltage Vin decreases or the load current increase, the output voltage decreases. The feed-back voltage VFB decreases as well. As a result, the feed-back error amplifier generates an increased gate voltage. This reduces the voltage drop VSD between source and drain and brings back the output voltage so that VFB equals VREF. In a similar way, the negative feed-back loop increases VSD when the output voltage goes up. As already mentioned, a major drawback of the linear power regulator is excessive power dissipation.

A switched power converter, in contrast, works by taking small chunks of energy, bit by bit, from an input voltage source, and moving them to the output. This is accomplished by means of an electrical switch and a controller which controls the rate at which energy is transferred to the output.

The energy losses involved in moving chunks of energy around in this way are relatively small, and the result is that a switched power converter may typically have a much high efficiency.

FIG. 2 shows a switched DC-DC converter comprising a switchable power stage 21, wherein an output voltage is generated according to a switching signal and an input voltage. The switching signal is generated in a digital control circuit that adjusts the output voltage Vout to a reference voltage VREF. The switched power stage 21 comprises a dual switch consisting of a high-side FET 22 and a low-side FET 23, an inductance 24 and a capacitor 25. During a charge phase, the high-side FET 22 is turned on and the low-side FET 23 is turned off by the switching signal to charge the capacitor. During a discharge phase the high-side FET 22 is turned off and the low-side FET 23 is turned on to match the average inductor current to the load current. The switching signal is generated as digital pulse width modulation (PWM) signal with a duty cycle determined by a control law. A switched power converter is suitable for high loads. When driving light loads, the duty ratio of the PWM signals becomes very small when implementing diode emulation. However, the on-time of the high-side FET cannot be made arbitrarily small. Hence, there is a minimum on-time requirement. Moreover, switching losses occur in a switched power converter.

Hence, what is needed is an energy efficient power converter, specifically when driving light loads.

### BRIEF SUMMARY OF THE INVENTION

A power converter and related method, substantially as shown in and/or described in connection with at least one of the figures, as set forth more completely in the claims.

The present disclosure relates to a switched power converter with a high-side switch operated in its linear mode. The efficiency of the power converter is greater than 50 percent. Losses are only d times that of a linear power converter, where d is the on-time relative period.

These and other advantages, aspects and novel features of the present disclosure, as well as details of an illustrated embodiment thereof, will be more fully understood from the following description and drawings.

### BRIEF DESCRIPTION OF THE DRAWINGS

Reference will be made to the accompanying drawings, wherein:

FIG. 1 shows a block diagram of a linear power converter;

FIG. 2 shows a block diagram of a switched power converter;

FIG. 3 shows the PWM signal, and the inductor current for pulsed linear regulation (solid line) and conventional switched regulation (dashed line) versus time;

FIG. 4 shows an efficiency measure versus Vo/Vin; and

FIG. 5 shows relative losses versus Vo/Vin.

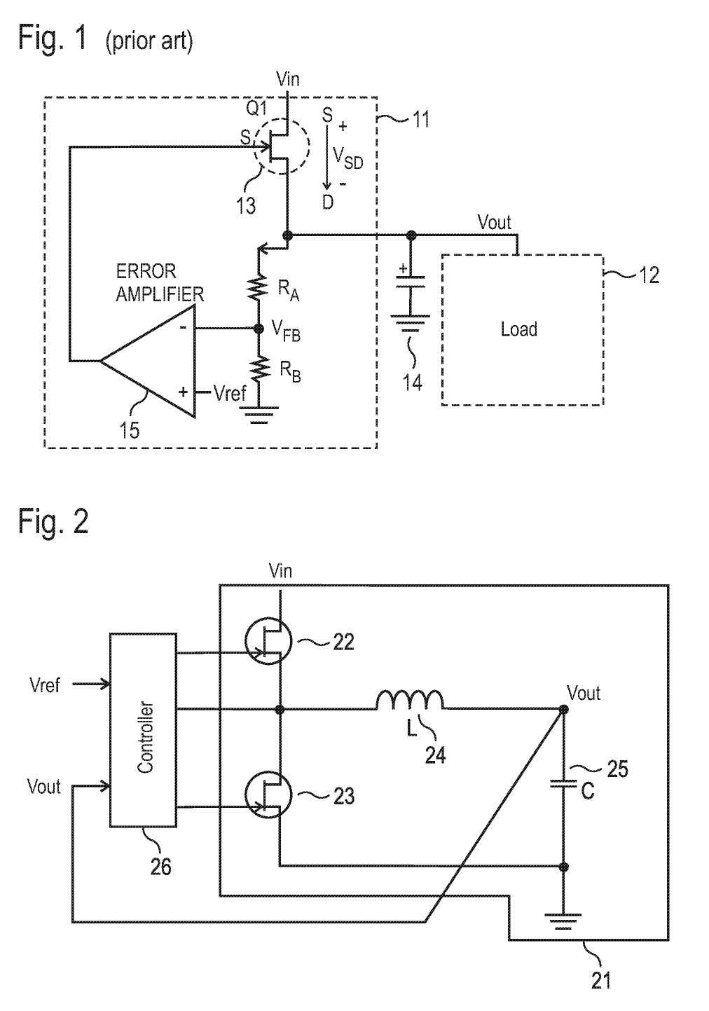

### DETAILED DESCRIPTION OF THE INVENTION

The present invention relates to a switchable power converter as shown in FIG. 2. The switchable power converter comprises a switchable power stage 21 for generating an output voltage according to a switching signal and an input voltage by means of a switching element comprising a high-side switch 22 and a low-side switch 23. In a light load mode the controller 26 is configured to disable, i.e. turn off, the low-side switch 13 and to generate the switching signal to partially turn on the high-side switch 12 during an on-time of the switching signal. The on-time of the switching signal is defined with respect to the operation of the high-side switch 22. In the light load mode, only low output currents arise. Alternately, instead of completely turning off the low side switch and using only the switch body diode as in the case of a FET, the low side switch can be turned on only when the body diode would otherwise be conducting current. By turning on the low side switch, the body diode losses are decreased and the efficiency is improved.

The controller is configured to generate the switching signal to partially turn on the high-side switch during the on-time of the switching signal by operating the high-side switch 22 in its linear region. Thus, the high-side switch 22 acts as resistor. Hence, the power converter is a pulsed linear power converter. However, the time that current is flowing through the resistive path comprising the high-side switch and a resistive load is greatly reduced compared to a linear power converter where current is flowing permanently.

As the high-side switch 22 does not need to be turned on completely on or off, gate drive requirements are reduced.

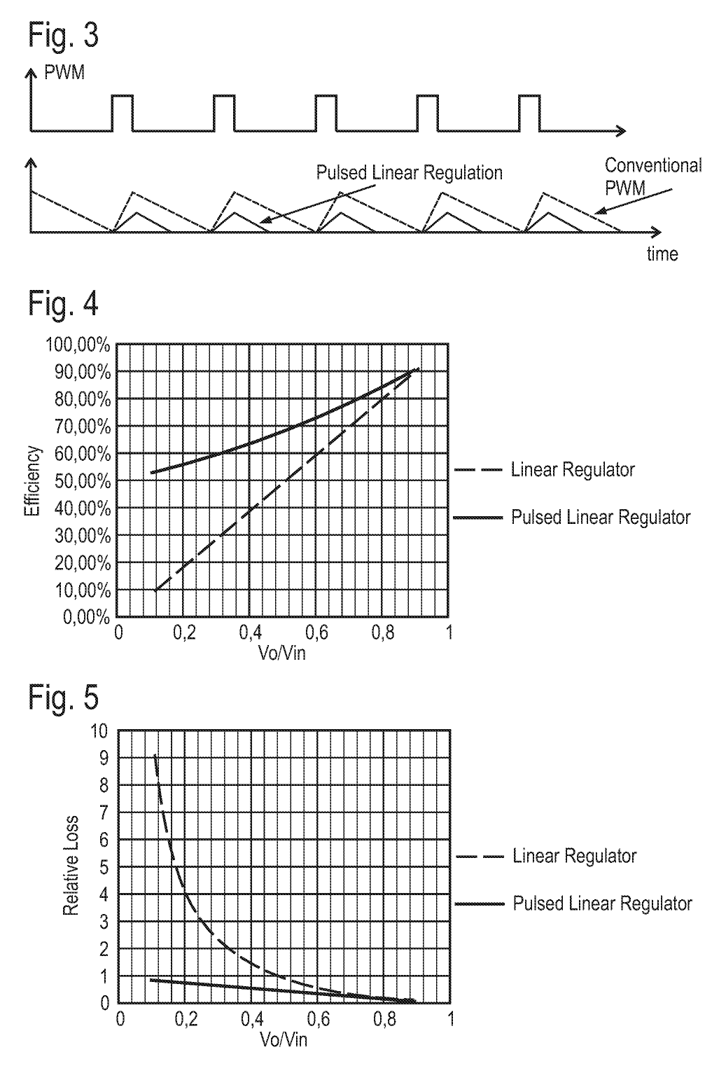

FIG. 3 shows the PWM signal, and the inductor current for pulsed linear regulation (solid line) and switched convention regulation (dashed line) versus time. The PWM signal is periodic with a duty ratio corresponding to the on-time. As the PWM signal goes up the inductor current rises. The inductor current peaks when the PWM signal goes down. It can be observed that inductor current for pulsed linear regulation peaks at the same time as the inductor current for conventional switched regulation. However, the magnitude of the inductor current at the peak is smaller for the pulsed linear regulation. This is due to the fact that the high-side switch is not turned on to an extent that the FET operates in its saturation region. Moreover, with pulsed linear regulation there are times when no inductor current is flowing compared to conventional PWM regulation and conventional linear regulation.

The efficiency of a conventional linear regulator is the ratio of output voltage to input voltage Vo/Vin.

FIG. 4 shows an efficiency measure versus Vo/Vin for pulsed linear regulation (solid line) and conventional linear regulation (dashed line). The efficiency of pulsed linear regulation is at least 50 percent. This is much higher than for conventional linear regulation which can be as low as 10 percent.

FIG. 5 shows relative losses versus Vo/Vin for pulsed linear regulation (solid line) and conventional linear regulation (dashed line). Losses are only d times that of conventional linear regulation, where d is the on-time relative to the period.

Referring back to FIG. 2, the controller may be further configured to toggle between the light load mode and a high load mode in which the switching signal is generated to alternatingly switch on and off the high-side switch and the low-side switch. Hence, the power converter may be operated as pulsed linear power converter in light load mode or as conventional switched power converter in high load mode. Thus, the present solution combines the advantages of pulsed linear regulation and conventional PWM regulation in a single device. The switchable converter can be advantageously adapted to deal with a wide range of loads. The switchable power converter may comprise means to determine whether it is driving a high load or a light load.

A minimum on-time of the switching signal in the light load mode may be smaller than a minimum on-time of the switching signal in the high load mode. Specifically, with pulsed linear regulation there may not be an on-time limitation at all, as the on-time is increased compared to conventional PWM switched regulation at very low duty ratios.

The present invention further relates to a method for controlling a switchable power converter comprising a switchable power stage with a dual switching element comprising a high-side switch and a low-side switch. The method comprises in a light load mode: disabling the low-side switch and generating a switching signal for turning on the high-side switch partially during an on-time of the switching signal. The present invention further relates to a computer readable medium having computer readable instructions for performing the method as described above.

What is claimed is:

1. A switchable power converter comprising:
a switchable power stage for generating an output voltage according to a switching signal and an input voltage by means of a switching element comprising a high-side switch and a low-side switch;
wherein in a light load mode the controller is configured to disable the low-side switch and to generate the switching signal to partially turn on the high-side switch during an on-time of the switching signal.

2. The switchable power converter according to claim 1, wherein the high-side switch is a transistor and wherein the controller is configured to generate the switching signal to partially turn on the high-side switch during the on-time of the switching signal by operating the transistor in its linear region.

3. The switchable power converter according to claim 2, wherein the controller is configured to generate the switching signal to operate the transistor in a linear region by adjusting the magnitude of the switching signal accordingly.

4. The switchable power converter according to claim 1, wherein the controller is further configured to toggle between the light load mode and a high load mode in which the switching signal is generated to alternatingly switch on and off the high-side switch and the low-side switch.

5. The switchable power converter according to claim 4, wherein a minimum on-time of the switching signal in the light load mode is smaller than a minimum on-time of the switching signal in the high load mode.

6. A method for controlling a switchable power converter comprising a switchable power stage with a dual switching element comprising a high-side switch and a low-side switch the method comprising:
in a light load mode:
disabling the low-side switch and
generating a switching signal for turning on the high-side switch partially during an on-time of the switching signal.

7. A method according to claim 6, wherein turning on the high-side switch partially comprises operating the high-side switch in its linear region.

8. A method according to claim 7, wherein operating the high-side switch in its linear region comprises adjusting the magnitude of the switching signal accordingly.

9. A method according to claim 6, the method further comprising toggling between the light load mode and a high load mode in which the switching signal is generated to alternatingly switch on and off the high-side switch and the low-side switch.

10. A method according to claim 6, the method further comprising:
reducing a minimum on-time of the switching signal in the light load mode compared to a high load mode.
